(19) United States
(12) Patent Application Publication
(10) Pub. No.: US 2017/0152155 A1
(43) Pub. Date: Jun. 1, 2017

(54) DEVICE FOR REMOVAL OF MOISTURE FROM WASTE AND METHOD THEREOF

(71) Applicant: Hasan SIGERGOK, Istanbul (TR)

(72) Inventor: Hasan SIGERGOK, Istanbul (TR)

(21) Appl. No.: 15/322,863

(22) PCT Filed: Jun. 29, 2015
(86) PCT No.: PCT/TR2015/050020

§ 371 Date: Dec. 29, 2016

(30) Foreign Application Priority Data
Jun. 30, 2014 (TR) 2014/07666

(51) Int. Cl. C02F 1/04; B01D 5/00; B09B 3/00; B01D 3/10

(52) U.S. Cl. CPC C02F 1/046; B01D 3/103; B01D 5/0042; B09B 3/0083; B09B 3/0025

(57) ABSTRACT

The present invention relates to a garbage dehumidifying device and a method thereof, wherein the garbage dehumidifying device comprises the following: an airtight first chamber (1) provided therein with the wet waste, a heater (14) for heating said first chamber, an airtight second chamber (8) connected with the first chamber so as to maintain the vacuum communication and a vacuum pump (10) connected to at least one of said chambers for creating vacuum inside said chambers.

### FIELD OF THE INVENTION

The present invention relates to a device and method thereof for dehumidifying wet waste (removing the moisture content thereof).

### BACKGROUND OF THE INVENTION AND KNOWN APPLICATIONS

Handling of waste containing moisture is difficult in many respects: They usually occupy a lot of space; cause bad smell due to time passes until being sent to the final waste location; and create favorable conditions for microbial growth due to the presence of damp environment.

Many suggestions are set forth for handling of wet waste. For example, the U.S. Pat. No. 5,253,764 document discloses a system for treatment and recovery of household waste. The system disclosed in the U.S. Pat. No. 5,253,764 document is generally intended for feeding cellulosic materials into a first vessel comprising hot water therein, applying vacuum thereto for bringing the moisture content to the desired level and then transferring the waste to another vessel to be separated into components thereof.

The WO9406576 document discloses a method for hygienic disposal of organic household waste by pulverizing, dewatering and drying thereof. The method according to the WO9406576 document describes collecting the waste, after being passed through a vertical chamber with an ascending hot air stream, in another chamber with countercurrent air flow.

On the other hand, distilling water from aqueous solutions comprising various impurities therein to obtain drinking water or tap water is known for many years in the art. In particular, various solutions proposed to obtain pure water from sea water covering ¾ of the earth are also quite well known. These methods are primarily divided into two groups: According to the first method, water containing impurities is passed through a filter having very small pores and catching impurity molecules larger than water molecules on the filter is provided (reverse osmosis). The other method is based on evaporating water containing impurities—generally under vacuum, thereby, separating pure water molecules in the form of vapor from the other impurity molecules thanks to the different boiling point thereof and finally, obtaining pure water in liquid form by condensing the water vapor.

On the basis of performance/cost criteria, both methods find application areas, wherein the present invention primarily uses the aforementioned second method of evaporating water containing impurities under vacuum and then distilling thereof by condensing the water vapor. To improve said method, numerous studies have been conducted in the art. For example, the U.S. Pat. No. 4,584,061 document discloses a portable, spherical tank for obtaining pure water from sea water. This tank comprises a chamber disposed at the lower portion thereof for taking in and evaporating sea water and a chamber disposed at the upper portion thereof for condensing the evaporated pure water.

The U.S. Pat. No. 7,641,771 document discloses a system comprising an entry chamber communicating with a source of polluted water, a pump for delivering water vapor from the entry chamber to the vapor chamber and an intermediate area chamber for delivering condensed water from the vapor chamber to a reservoir of purified water.

These documents provided herein just for representing the prior art deal with distillation of water from an aqueous solution such as only sea water with a high content (about 95%) of pure water. For example, they are not intended for distilling water from organic wet waste such as food waste. However, obtaining pure water from wet waste has two major outcomes: Obtaining drinking or tap water and providing proper conditions for the disposal of organic waste by reducing the moisture content thereof. In fact, combating waste free of moisture is easier, for example, in the incineration method. In addition, since waste (municipal waste) is discharged to the waste facility without being treated, complex organic molecules decompose due to the activity of microorganisms in the waste and methane gas is released. Methane gas accumulates in piles of garbage if remains therein and causes an explosion with the increasing temperature (in the past, deaths resulted from the explosions due to accumulation of methane gas are known).

### DESCRIPTION OF THE INVENTION

The object of the present invention is to effectively remove moisture content of the wet waste.

Another object of the present invention is to effectively reduce the volume occupied by the wet waste.

Another object of the present invention is to enable hygienic disposal of wet waste.

Another object of the present invention is to effectively obtain distilled water from wet waste.

The present invention, to achieve the aforementioned objects, relates to a garbage dehumidifying device comprising the following: an airtight first chamber provided therein with the wet waste, a heater for heating said first chamber, an airtight second chamber connected with the first chamber so as to maintain the vacuum communication and a vacuum pump connected to at least one of said chambers for creating vacuum inside said chambers.

The garbage dehumidifying device according to the present invention can also comprise a compactor for compacting the garbage disposed in the first chamber.

According to an embodiment of the present invention, to obtain distilled water from the moisture of the garbage with the moisture content thereof being removed, the moisture content of the wet waste inside first chamber is evaporated by the effect of vacuum and heat, collected in the second chamber, the water vapor contacting the cold walls of said chamber condenses and passes into the pure water phase, then, it is sent therefrom to a reservoir communicating with the vacuum pump and collected therein to be used.

Further, according to a preferred embodiment of the present invention, a filter allowing passage of only the water vapor molecules can be disposed between the first chamber and second chamber.

According to a preferred embodiment of the present invention, the second chamber can be cooled by a cooling source. In such a case, a thermoelectric cooler (Peltier device) can be provided between the first chamber and second chamber, thereby, while the first chamber is heated, simultaneously, the second chamber is cooled.

According to a preferred embodiment of the present invention, the first chamber is disposed at a position higher than that of the second chamber.

According to one embodiment of the present invention, pure water is passed through a filter at the outlet of the second chamber and then sent to the reservoir. Thus, other impurities remaining in pure water are further purified by passing it through an additional stage.

According to another embodiment of the present invention, the amount of distilled water collected in the reservoir can be supplemented with pure water to be obtained from other waste containing high amounts of water therein. For example, used water flowing through the sink can be stored inside another chamber (third chamber), in this case, the third chamber can be connected with the other first and second chambers in an airtight manner and condensation of the pure water inside the second chamber after being evaporated in the third chamber can be provided.

The present invention also comprises a method for removing moisture content of the wet waste, wherein it comprises the following steps:
placing the wet waste into an airtight first chamber;
heating the wet waste;
applying vacuum to the first chamber comprising the wet waste; and
evaporating the moisture content of the wet waste and removing the resulting moisture content from the first chamber.

According to a preferred embodiment of the present invention, the water vapor removed from the first chamber is sent to a second chamber. Then, the water vapor in the second chamber is condensed, thus, water distillation is provided.

The method according to the present invention can further comprise the following steps: collecting the water condensed in the second chamber in a reservoir; passing the pure water through a filter before sending thereof to the reservoir; and cooling of the second chamber by means of a cooling source.

### DESCRIPTION OF THE FIGURES

FIG. 1 illustrates a representational view of the dehumidifying device according to the present invention.

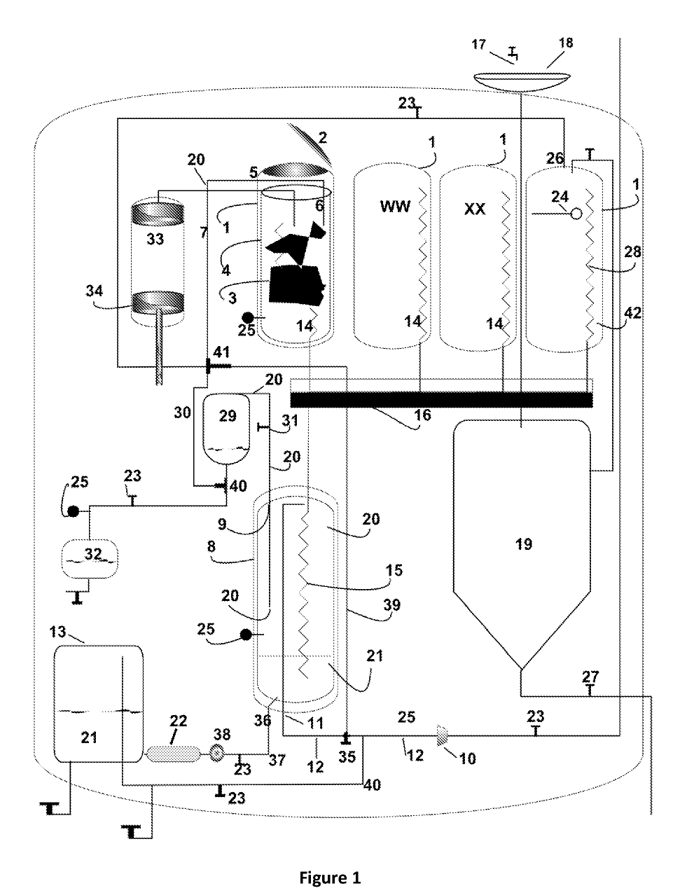

### REFERENCE NUMBERS OF THE PARTS IN FIGURES

1 First chamber

2 First chamber cover

3 Wet waste

4 Waste bag

5 First chamber opening

6 Bag inlet

7 Chamber connection pipe

8 Second chamber

9 Second chamber opening

10 Vacuum pump

11 Pump connection opening

12 Pump connection pipe

13 Reservoir

14 Heater

15 Cooler

16 Thermoelectric cooler (Peltier device)

17 Tap

18 Sink

19 Third chamber

20 Water vapor

21 Distilled water

22 Filter

23 One-way valve

24 Third chamber water with impurities

25 Manometer

26 Third chamber opening

27 Discharge opening

28 Heater

29 Water vapor filter

30 Water vapor filter inlet line

31 Water vapor filter outlet line

32 Foreign substance reservoir

33 Compactor

34 Compactor piston

35 Main line valve

36 Water suction pipe connection opening

37 Water suction pipe

38 Water suction pump

39 By-pass line

40 By-pass three-way valve

41 Three-way valve

42 Backup chamber

### DETAILED DESCRIPTION OF THE INVENTION

The term “wet waste” used throughout this description refers to any type of wet garbage such as daily household garbage disposed for example from a home. Because, already, organic waste such as food and drink leftovers are sent by trucks to the waste treatment plants in many places around the world after being placed together with the other dry packaging waste (paper, plastic, metal and glass) into the same bag. It should be appreciated that the term “household” also used throughout this description includes, other than ordinary homes, buildings with a central kitchen such as hotels, educational institutions, military complexes, food companies and production facilities.

Wet waste (3), after being placed into a first chamber (1), cover (2) of the chamber (1) is closed in an airtight manner. In cases providing convenience to the user, wet waste (3) can be placed into the first chamber (1) after being initially placed into a waste bag (4). The first chamber (1) comprises an opening (5) and this opening (5) is preferably disposed at a position near the upper portion thereof. A chamber connection pipe (7) is connected to the first chamber opening (5) in an airtight manner. The chamber connection pipe (7) can comprise a bag inlet pipe (6) extending toward the interior portion of the first chamber (1) as well as the interior portion of the waste bag (4).

The chamber connection pipe (7) is connected from the other end thereof to a second chamber (8) disposed preferably at a position lower than that of the first chamber in an airtight manner by means of a second chamber opening (9).

The second chamber (8) itself is also an airtight chamber. The second chamber (8) is connected to a vacuum pump (10) using a pump connection pipe (12) through a pump connection opening (11) disposed at the lower portion thereof. At the lower portion of the second chamber (8) a water suction pipe connection opening (36) is formed and a water suction pipe (37) is connected to said opening (36). The water suction pipe (37) is connected to a reservoir (13) at the other end thereof. To send the water from the water suction pipe (37) to the reservoir (13), a water suction pump (38) is also provided on the water suction pipe (37). A one-way valve (23) is provided on the pump connection pipe (12) for the air advancing through the pump connection pipe (12) by the suction of the vacuum pump (10) to return to the pump (10) as water vapor.

The vacuum pump (10) is disposed at the upper side portion of the second chamber (8), wherein it can also be positioned at a point between the first chamber (1) and second chamber. A filter (22) is optionally provided on the water suction pipe (37) and inlet portion of the reservoir (13) and distilled water (21) can be further purified by means of said filter (22). Distillation level of the water in the reservoir (13) can be controlled by means of a pH meter, thus, an indication of the pH level of the distilled water in the reservoir is provided according the intended drinking or tap water use.

The first chamber (1) is heated when desired with preferably an adjustable heating power by means of a heater (14) disposed preferably at the lower portion thereof. This heater (14) is a heater known in the art such as a resistor, heat pump, microwave heater.

When vacuum pump (10) starts to perform suction, a vacuum is created inside the main line valve (35), second chamber (8) and the first chamber (1) connected thereto by means of the chamber connection pipe (7). Meanwhile, since the first chamber (1) is heated by means of the heater (14), water present in the wet waste (3) evaporates when suitable conditions form, thus, it is separated from the impurities thereof. Herein, “suitable conditions” term is used due to the change in the boiling temperature of water according to the vacuum being applied thereto. For example, temperature required for evaporation of water at 611 Pa (0.611 kPa) is 274.16 K (1.01° C.). According to the preferred embodiment of the present invention, vacuum value applied by the vacuum pump (10) is in the range of 650 Pa to 50.000 Pa (50 kPa). Thus, by maintaining the heater power at relatively low levels, the process becomes more perfect, faster and undesired chemical reactions are prevented. According to the preferred embodiment of the present invention, heating the first chamber is initiated before operating the vacuum pump (10), wherein it is also possible to initiate heating after a desired period of time following initial application of vacuum to the first chamber.

A main line valve (35) is provided on the chamber connection pipe (7). This main line valve (35) remains open for a certain period of time after the vacuum pump (10) starts to operate. This duration corresponds to the time until a certain vacuum and temperature values inside the chambers (1, 8) are reached, these values are the conditions required for the formation of water vapor in the wet waste (3). A by-pass line (39) is provided on the chamber connection pipe (7) and a water vapor filter (29) is provided on the chamber connection pipe (7). This water vapor filter (29) is a filter of the type known in the art allowing passage of only water vapor molecules therethrough. Use of such a filter (29) can be of particular importance due to the complex chemical structure present in the wet waste, because, other chemical molecules capable of evaporating (at the same vacuum value) at a temperature lower than that of the water can be present in the waste (3).

On the by-pass line (39), a by-pass line valve (40) is disposed on the line (30) at the inlet of the water vapor filter (29). A three-way valve (41) is positioned before the by-pass line valve (40) in the vacuum suction direction. The chamber connection pipe (7) leaving the first chamber is connected to the filter (29) after it passes through the three-way valve (41). The by-pass line valve (40) is in closed position towards by-pass line 39 when the three-way valve (41) is open. The by-pass line valve (40) opens when the three-way valve (41) is opened towards the water vapor filter outlet line (31) and water vapor flow from the first chamber (1) into the second chamber is realized through the water vapor outlet line (31) (thus, through the water vapor filter (29)). The water vapor filter (29) is further connected to a foreign substance reservoir (32) through another line, thus, filtered foreign substances in vapor form other than the water vapor is collected in this reservoir. A one-way valve (23) is provided at the outlet of the reservoir.

The vacuum pump (10) operates only when the vacuum value of the system falls below a certain value and to enable this, a manometer (25) is preferably disposed on the connection pipe (12) provided between the vacuum pump (10) and second chamber (8). The manometer (25) output pressure can be converted into digital data by means of a transducer and fed to a control unit and vacuum pump (10) can be controlled by connecting it to the control unit. These lastly mentioned control unit and the transducer are not shown in the figure, however, digital control of the vacuum pump, as known from the art, is a routine practice.

The water vapor (20) obtained from wet waste is directed towards the second chamber (8) being initially empty and positioned at a location lower than the first chamber. The water vapor (20) striking the cold walls of the second chamber (8) condenses, thus, moisture content of the wet waste (3) inside the first chamber (1) is removed as well as distilled water (21) is obtained in the second chamber (8) and this distilled water is sent to the reservoir (13) by means of the water suction pump (38). To increase the condensation in the second chamber (8), the walls of the second chamber (8) can also be cooled by a cooler (15). An open one-way valve (23) is provided at the front portion of the water suction pump (38) and on the water suction pipe (37) in the direction of chamber-reservoir and return of the distilled water into the second chamber (8) is prevented thanks to this valve.

In case of performing heating of the first chamber (1) and cooling of the second chamber (8) simultaneously, utilization of a thermoelectric cooler (Peltier device) (16) can be advantageous. Because, thermoelectric coolers generally comprise a structure with plates, when voltage is applied, a surface thereof heats up and the other surface thereof cools down. The same principle also applies to the heat pump, however, operating efficiency of the thermoelectric coolers is incomparably higher.

When distilled water is desired to be obtained from the garbage device according to the present invention, the amount of distilled water can be supplemented with the distillation of the waste with a relatively high proportion of water content. For example, waste water running through a tap (17) and used for washing hands can be collected inside at least a third chamber (19) arranged at the lower portion of a sink (18). To do this, the third chamber (19) is connected to the second chamber (8) through a chamber connection pipe (7) in an airtight manner. The chamber connection pipe (7) is attached to the third chamber opening (26) formed at a point inaccessible by the waste water and at the upper portion of the third chamber (19). Level of the water with impurities (24) inside the third chamber (19) can be controlled by means of a level control sensor. The water with impurities (24), when the level thereof reaches the maximum allowable level determined by the sensor, is discharged through a discharge opening (27) disposed at the lower portion of the third chamber (19) by means a control unit. The backup chamber (42), by being heated with a heater (28) as in the case of the first chamber (1), also enables the pure water to boil at a lower temperature than that of the water with impurities (24) under vacuum.

The waste with a relatively high proportion of water content can be the waste with a pure water content of above 50% by weight, for example, 80-99% by weight. For example, contaminated water running through the sink or bathtub drain and used for personal hygiene can be such a waste with a relatively high proportion of water content.

The present invention comprises a method for removing the moisture content of the wet waste, wherein it also comprises the following steps:
placing the wet waste (3) into an airtight first chamber (1);
heating the wet waste (3);
applying vacuum to the first chamber (1) comprising the wet waste (3); and
evaporating the moisture content of the wet waste (3) and removing the resulting moisture content from the first chamber (1).

Removing the moisture content from the first chamber is preferably carried out under vacuum.

The garbage method according to the present invention can further comprise the steps of sending the moisture content removed from the first chamber (1) to a second chamber (8) as water vapor and condensing the water vapor in the second chamber (8).

The method according to the present invention can further comprise the step of collecting the water condensed in the second chamber (8) in a reservoir (13). The method according to the present invention can further comprise the following steps: passing the pure water through a filter (22) before sending thereof to the reservoir (13); and cooling of the second chamber (8) by means of a cooling source (15). Cooling of the second chamber (8) is preferably carried out simultaneously with heating of the first chamber (1).

After the dehydrating process is completed, the dried wet waste (3) present in the first chamber (1) can be placed into a compactor (33), compacted by means of a compactor piston (34) comprised therein, thus, it can occupy less space. According to the preferred embodiment of the present invention, the compactor (33) comprises a hydraulic piston-cylinder mechanism, wherein it can also comprise an arrangement with a pneumatically driven or electric motor driven piston.

1. A garbage dehydrating device, wherein it comprises the following: an airtight first chamber (1) provided therein with the wet waste (3), a heater (14) for heating said first chamber (1), an airtight second chamber (8) connected with the first chamber (1) so as to maintain the vacuum communication and a vacuum pump (10) connected to at least one of said chambers (1, 8) for creating vacuum inside said chambers (1, 8).

2. The device according to claim 1, wherein it comprises a chamber connection pipe (7) providing the connection between the first chamber (1) and second chamber (8) and said chamber connection pipe (7) comprises a by-pass line and a water vapor filter (29) disposed on said by-pass line.

3. The device according to claim 2, wherein it comprises a by-pass line valve (40) disposed on the line (30) at the inlet of the water vapor filter (29).

4. The device according to claim 1, wherein it comprises a three-way valve (41) positioned before the by-pass line valve (40) in the vacuum suction direction.

5. The device according to claim 1, wherein the by-pass line valve (40) is in closed position towards by-pass line (39) when the three-way valve (41) is open, the by-pass line valve (40) opens when the three-way valve (41) is opened towards outlet line (31) of the water vapor filter (29).

6. The device according to claim 1, wherein it comprises a water suction pipe (37) provided at the lower portion of the second chamber (8) and it comprises a reservoir (13) provided at the other end of the water suction pipe (37).

7. The device according to claim 1, wherein the vacuum pump (10) is positioned at the lower portion of the second chamber (8) or at a point between the first chamber (1) and second chamber.

8. The device according to claim 2, wherein it comprises a filter (22) positioned at the front portion of the reservoir (13).

9. The device according to claim 1, wherein it comprises a cooler (15) for cooling the second chamber (8).

10. The device according to claim 9, wherein the cooler for the second chamber (8) and the heater for the first chamber (1) are a cooler and a heater of a thermoelectric device (16), respectively.

11. The device according to claim 1, wherein it comprises a manometer (25) measuring the vacuum value provided for controlling the vacuum pump (10).

12. The device according to claim 1, wherein the first chamber (1) is disposed at a position higher than that of the second chamber (8).

13. The device according to claim 1, wherein it comprises at least a third chamber (19) comprising therein waste with a relatively high proportion of water content and connected to the second chamber (8) to supplement the water distilled from the wet waste (3).

14. The device according to claim 14, wherein it comprises a heater (28) for heating the third chamber (8).

15. The device according to claim 14, wherein the waste with a relatively high proportion of water content is the waste with a pure water content of preferably 80-99% by weight.

16. A method for removing the moisture content of the wet waste, wherein it also comprises the following steps:
placing the wet waste (3) into an airtight first chamber (1);
heating the wet waste (3);
applying vacuum to the first chamber (1) comprising the wet waste (3); and
evaporating the moisture content of the wet waste (3) and removing the resulting moisture content from the first chamber.

17. The method according to claim 16, wherein removing the moisture content from the first chamber is preferably carried out under vacuum.

18. The method according to claim 16, wherein it further comprises the steps of condensing the water vapor in the second chamber (8) and collecting the water condensed in the second chamber (8) in a reservoir (13).

19. The method according to claim 16, wherein it further comprises the step of cooling the second chamber (8) by a cooling source (15).

20. The device according to claim 1, wherein it comprises a compactor (33) for compacting the dried wet waste (3) in the first chamber (1) after the dehydrating process is completed.

21. (canceled)
